(19) United States
(12) Patent Application Publication
(10) Pub. No.: US 2024/0114823 A1
(43) Pub. Date: Apr. 11, 2024

(54) PLANTING DEVICE WITH ADJUSTABLE PLANTING DEPTH

(71) Applicant: AGRIPLANT NV, LANGEMARK (BE)

(72) Inventor: Bart PARREIN, LANGEMARK (BE)

(21) Appl. No.: 18/475,171

(22) Filed: Sep. 26, 2023

(30) Foreign Application Priority Data
Oct. 7, 2022 (BE) 2022/5805

(51) Int. Cl. A01C 11/02; A01C 11/00

(52) U.S. Cl. CPC A01C 11/02; A01C 11/006

(57) ABSTRACT

The present disclosure relates to a planting device for placing planting material in the ground, including a frame movable in a direction of travel, feeders for delivering the planting material to be planted, and, fitted on the frame, rotatable planters provided for gripping the supplied planting material and bringing it into the ground. The feeders may also include first and second feeders that extend respectively in a horizontal plane and towards the ground, where the second feeders are configured to transport the planting material supplied by the first feeder to the rotatable planter, and where the first and second feeding feeders are movable relative to each other, for adjusting the planting depth of the planting material.

This application claims the benefit of Belgian Patent Application No. BE2022/5805, filed Oct. 7, 2022, which is hereby incorporated by reference in its entirety.

### FIELD OF THE DISCLOSURE

The present disclosure relates to a planting device for placing planting material in the ground, comprising a frame movable in a direction of travel, feeders for delivering the planting material to be planted, and rotatable planters fitted on the frame, provided for gripping the supplied planting material and placing it in the ground.

The planting device according to some embodiments of the invention is particularly suitable for planting seedlings. Seedlings are plants raised from seed; they comprise a root ball and a plant with an underground portion that extends largely into the root ball and an above-ground portion that extends at the top of the root ball so that the seedlings extend in a longitudinal direction and the above-ground portion has a certain dimension, viewed in the longitudinal direction.

### BACKGROUND

When growing plants whose seeds are relatively expensive, such as cauliflower, broccoli, tomatoes, celery, onions, lettuce, leeks, etc., seedlings are often used. Seedlings are usually obtained by placing a seed in a ball of soil and allowing this seed to germinate to a seedling so that we then have a plant with a root ball. The seedlings may also be obtained by placing the seeds in a seed bed or in an outdoor bed and then dividing up the seed bed or the outdoor bed into root balls. Seedlings can also be obtained by placing plant cuttings, saplings, shrubs, and bulbs in balls of soil.

The seedlings are applied on a field. The application of seedlings on a field may also be indicated with the term “planting of seedlings” or “transplanting of seedlings”. A planter (planting device) may be used for this. A planter is also indicated with the terms “transplanter” or “planting machine”. When applying the plants on the field by means of a planter, there is already a portion of the plants that is intended to extend mainly above ground and when applying these plants on the field, it will be ensured that this portion therefore extends mainly above ground. The root ball with the seedling is then planted by the planter on the field and often, after their growing period, the plants are harvested individually (one by one).

Various types of planters for placing planting material in the ground are already known. These planters are constructed from a self-propelled or trailed frame provided with a drill coulter for applying one or more parallel furrows in the ground, feeding means for feeding the planting material to be planted, a mechanism for placement of individual plants in the applied furrows and a system in the form of pressure rolls or pressure wheels with which the furrows are closed up again. The planting mechanism generally comprises rotatable planters in the form of for example two planting disks that are positioned relative to each other in such a way that along part of the periphery of both disks, at certain places a clearance is created for bringing the planting material into a pick-up zone between the disks and, in a delivery zone, dropping the planting material from the planters into a furrow provided in the ground.

Usually seedlings are applied on a field by the planter in such a way that the root ball extends substantially below the soil surface of the field. The above-ground portion is then the portion of the seedling that extends above the soil surface of the field and the underground portion of the seedling is then the portion of the seedling that extends below the soil surface of the field. However, these seedlings may also be applied on the field by the planter in such a way that (a part of) the root ball extends above the soil surface of the field. The above-ground portion of the seedling is then the portion of the seedling that extends above the root ball. In practice, seedlings are applied in the ground in such a way that there is about 3 to 4 cm of soil above the root ball. However, depending on the region (soil condition) and the species of seedling, it may be necessary to plant the seedlings deeper or less deep.

In the existing known systems the planting depth can be changed by changing the position of the planting disk relative to pressure rolls or pressure wheels with which the furrows are closed up again. However, this has the drawback that when the position of the planting disk is changed, not only the planting depth will change, but also the angle at which the plant is brought into the ground by the planting disk, so that an additional adjustment of the planting disks is required.

Another way of changing the planting depth is by moving the planting disks further forward or further back relative to the feeding means. As a result, the plant will be carried higher or lower by the planting disk, and the planting depth will change. However, this solution has the drawback that a number of plants, in particular those with a shorter above-ground part or when the above-ground part does not stand nice and straight, will no longer be carried along by the planting disks when these are placed farther from the feeding means.

The American patent publication U.S. Pat. No. 3,719,158 describes an automatic planter for planting plants such as tomatoes, tobacco, celery, cabbage, onions and the like, which is suitable for receiving thereon a magazine loaded with plants that is provided with uniform cavities suitable for the holding and moving of plants. The magazine is movable by means of a conveyor mounted on the machine. A pair of converging resilient endless belts positioned next to each other, which are configured for taking the plants from the magazine loaded with plants, have a downward trajectory that leads to a position adjacent to the ground. The endless belts then diverge to release the plants. The conveyor is adjustable vertically to provide the desired depth for planting the plants in the ground.

JP S61 128813 A suggests a movable guide on a first conveyor belt for adjusting the planting depth.

JP H07 213114 A suggests a movable planting device for adjusting the distance from a second belt in order to adjust the planting depth.

### SUMMARY

An aim of the present disclosure is now to provide a planting device which no longer has the aforementioned drawbacks and which allows the planting depth of planting material, particularly seedlings, to be adjusted in a simple manner.

That aim of the disclosure may be achieved by providing a planting device for placing planting material in the ground, comprising a frame movable in a direction of travel, feeders for delivering the planting material to be planted, and rotatable planters fitted on the frame, provided for gripping and placing the supplied planting material in the ground, wherein said feeders comprise first and second feeders that extend, respectively, in a horizontal plane and towards the ground, wherein the second feeders are configured for delivering the planting material supplied by the first feeders to the rotatable planters, and wherein the first and second feeders are movable relative to each other, in order to adjust the planting depth of the planting material, wherein the first feeders supply the planting material to be planted in a first feed direction and wherein the position of the first feeders relative to the second feeders is movable horizontally in a direction transverse to the first feed direction, so that the planting depth of the planting material is adjustable.

Because the position of the first feeders is adaptable to the position of the second feeders, the planting material supplied by the first feeders can be brought further back or further forward into the second feeders. As a result, the planting material supplied by the second feeders is gripped lower or higher at the level of its above-ground portion by the planters and the plants thus end up less deep, at a first planting depth or deeper, at a second planting depth in the ground, preferably in a furrow that has been provided, while the position of the planters relative to the ground remains unchanged. With a planting device of this kind, it is consequently easy to adjust the planting depth in a simple manner as a function of for example the soil conditions or the type of planting material.

The first feeders preferably extend in a horizontal plane, preferably in a direction transverse to the direction of travel of the planting device. The second feeders bring the planting material supplied by the first feeders towards the ground, and the second feeders preferably extend in a slanting or vertical plane, preferably in a direction transverse to the direction of travel of the planting device.

The aforementioned rotatable planters of the planting device according to some embodiments of the invention preferably comprise two planting disks that are positioned relative to each other in such a way that at certain places along part of the periphery of the two disks, a clearance is created for bringing the planting material into a pick-up zone between the disks and, in a delivery zone, dropping the planting material from the planters into a furrow provided in the ground. In the other part of the periphery, no clearance is created, because the two disks are pressed against each other by for example a pressing device provided for this purpose. In the part where there is no clearance, the planting material is clamped between the two planting disks.

Therefore the planting material is movable rotatably from the pick-up zone to the delivery zone. In use, the planting disks will rotate at a speed from 30 to 130 revolutions per minute.

In the planting device according to some embodiments of the invention, the first feeders deliver the planting material to be planted in a first feed direction and the position of the first feeders relative to the second feeders is movable horizontally in a direction transverse to the first feed direction, so that the planting depth of the planting material is adjustable. The planting depth of the planting material is easily changed by altering the position of the first feeders relative to the second feeders.

In a more preferred embodiment of the planting device according to the invention, the first feeders comprise at least one first conveyor belt. This first conveyor belt is configured to supply the planting material to the second feeders in such a way that the planting material does not get damaged. Preferably the first feeders are configured as a selecting device that is provided for separating suitable seedlings from unsuitable seedlings. Suitable seedlings are the seedlings that comprise a sufficiently well-developed above-ground portion and thus comprise an above-ground portion with a certain minimum height. Unsuitable seedlings are the seedlings that only comprise a root ball or an insufficiently developed above-ground portion and thus comprise an above-ground portion that is too small. The selecting device will separate the seedlings into two streams on the basis of the size of the above-ground portions in the height direction, and thus on the basis of the height of the above-ground portions.

According to a particular embodiment of the planting device according to the invention, the second feeders comprise two clamping bands extending towards the ground, between which the planting material supplied by the first feeders is transported in the direction of the planters. Preferably said clamping bands extend slanting or vertically. In practice, the second feeders will rotate faster than the first feeders. Preferably the second feeders rotate 5 to 25 times faster than the first feeders.

Preferably, in use, the second feeders will maintain a translation speed (feed speed) that is identical to the travelling speed of the planting device. The travelling speed of the planting device is selected as a function of the planting distance. In practice the travelling speed is between 3 and 13 km/h.

In a more particular embodiment of the planting device according to the invention, said planting device comprises one or more drill coulters for making one or more furrows and the planting device is configured to bring the planting material into the one or more furrows and the planting device comprises one or more pressure rolls or pressure wheels for closing up the one or more furrows again after the planting material is applied in the one or more furrows.

### BRIEF DESCRIPTION OF THE DRAWINGS

The present invention is now explained in more detail on the basis of the following description of a preferred embodiment of a planting device according to the present invention. The purpose of this description is exclusively to give illustrative examples and indicate further advantages and features, and is thus by no means to be interpreted as a limitation of the field of application of the invention or of the patent rights claimed in the claims.

In this description, reference is made by means of reference numbers to the appended drawings, where:

FIG. 1 is a top view of a schematic representation of the first and second feeders of a planting device according to some embodiments of the invention, wherein the first feeders are arranged in a first position relative to the second feeders;

FIG. 2 is a side view of what is shown in FIG. 1;

FIG. 3 is a top view of a schematic representation of the first and second feeders of a planting device according to some embodiments of the invention, wherein the first feeders are arranged in a second position relative to the second feeders;

FIG. 4 is a side view of what is shown in FIG. 3:

FIG. 5 is a simplified representation of a planting device according to some embodiments of the invention in its first position as shown in FIG. 1, during application of seedlings on a field, wherein the seedlings are applied at a first planting depth;

FIG. 6 is a simplified representation of a planting device according to some embodiments of the invention in its first position as shown in FIG. 3, during application of seedlings on a field, wherein the seedlings are applied at a second planting depth;

FIG. 7 is a perspective view of a planting device according to some embodiments of the invention;

FIG. 8 is a detailed illustration of the first and second feeders, the planting means and the pressure rolls of the planting device according to some embodiments of the invention.

### DETAILED DESCRIPTION

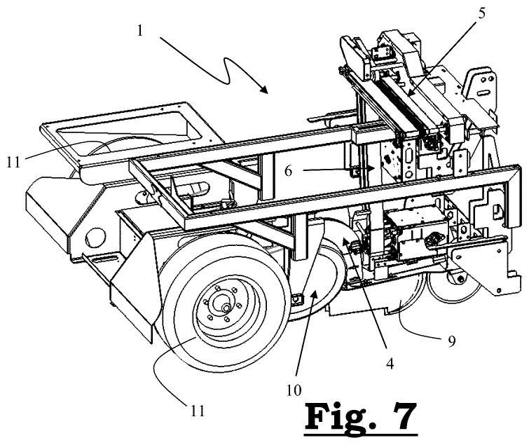

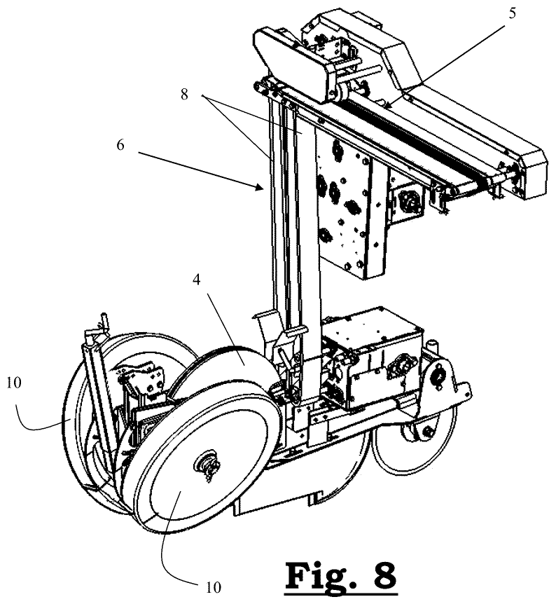

The planting device (1) according to some embodiments of the present invention and as shown inter alia in FIG. 7, is configured for applying planting material (2), such as seedlings, on a field in such a way that the planting material (2), after application thereof on the field, has an above-ground portion that extends above ground and an underground portion (root ball) that extends underground. In use, the planting device (1) will move over a field in a direction of travel (R).

The planting device (1) according to some embodiments of the present invention comprises a self-propelled or trailed frame (3) which forms the base of the device (1). The frame (3) is moved over the ground and comprises running wheels (11) for this purpose. The frame (3) is provided with a drill coulter (9) for making one or more parallel furrows in the ground, feeders for delivering the planting material to be planted (2), planting means (4) for placing individual plants in the furrows provided and pressure rolls (10) (or pressure wheels) with which the furrows are closed up again after the planting material (2) has been applied. The drill coulter (9) is built up from a V-shaped element that in use is brought partially into the ground.

The planting means (4), preferably in the form of two disk-shaped elements (so-called planting disks), are rotatable relative to the frame (3) and are provided for gripping the supplied planting material (2) and bringing it into the ground. They are positioned relative to each other in such a way that at certain places along part of the periphery of the two disks, a clearance is created for bringing the planting material into a pick-up zone between the disks and, in a delivery zone, dropping the planting material from the planting means into a furrow provided in the ground. In order to move the planting material (2) from the pick-up zone to the delivery zone, the two disks are pressed against each other by means of a pressing device (carriage) provided for this purpose, over another part of the periphery, so that it is possible to grip and move the applied planting material.

The planting material (2) is delivered with the aid of feeders. There are first (5) and second (6) feeders. On the device shown, the first feeders (5) extend horizontally and transversely to the direction of travel (R), whereas the second feeders (6) extend vertically towards the ground.

The first feeders (5) are configured to move the planting material (2) to the second feeders (6), which in their turn are configured to move the planting material (2) downwards to a delivery position where they are picked up one by one by the planting means (4), which will bring them into the ground. In use, the planting material to be planted (2) is always placed in the same position on the transport surface of the first feeders, so that the planting material in question is always picked up at the same place by the second feeders.

The first feeders (5) may consist of a single conveyor belt (7) that extends horizontally, preferably transversely to the direction of travel, and is configured to support and move the planting material (2), preferably a seedling comprising a root ball and a plant rooted in the root ball, to the second feeders. However, the first feeders (5) may also, as shown in the appended figures, consist of a so-called selecting device, which will be used for separating suitable seedlings from unsuitable seedlings. This selecting device comprises a number of conveyor belts.

The selecting device is question is configured to separate the planting material (2), hereinafter called seedlings, into two streams of seedlings on the basis of the size of their above-ground portions, namely a stream of seedlings with a sufficiently well-developed above-ground portion with a certain minimum height, for which there is a high probability that they will grow into harvestable plants, and a stream of unsuitable seedlings with an above-ground portion that is too small (too short). The root balls of all seedlings have practically the same dimensions so that separation of the seedlings is possible on the basis of the height of the above-ground portion.

The selecting device comprises a first conveyor belt (7) and second conveyor belt (12). The second conveyor belt (12) extends horizontally and is provided for transporting seedlings to an end zone of the second conveyor belt (12). Each seedling then rests on the second conveyor belt (12) in such a way that a lateral surface of the root ball rests on the second conveyor belt (12). The first conveyor belt (7) is placed in the extension of the second conveyor belt (12) and always occupies the same fixed position relative to the second conveyor belt (12). The first conveyor belt (7) is configured to transport seedlings (2) from a start zone of the first conveyor belt (7) to an end zone of the first conveyor belt (7). The first conveyor belt (7) has a certain slope so that the start zone of the first conveyor belt (7) is lower than the end zone of the first conveyor belt (7) and is also lower than the end zone of the second conveyor belt (12). Between the second conveyor belt (12) and the first conveyor belt (7), there is an opening through which the unsuitable seedlings fall under the effect of gravity.

The selecting device further comprises a gripping unit comprising gripping means which are configured to grip above-ground portions of seedlings and transport them to the start zone of the first conveyor belt (7). The gripping means are arranged in such a way that only the seedlings with a sufficiently high above-ground portion are gripped so that this first stream of seedlings is transported further by the first conveyor belt (7). The seedlings that were not gripped by the gripping means are unsuitable. The seedlings in the first stream are then the suitable seedlings and the seedlings in the second stream are then the unsuitable seedlings.

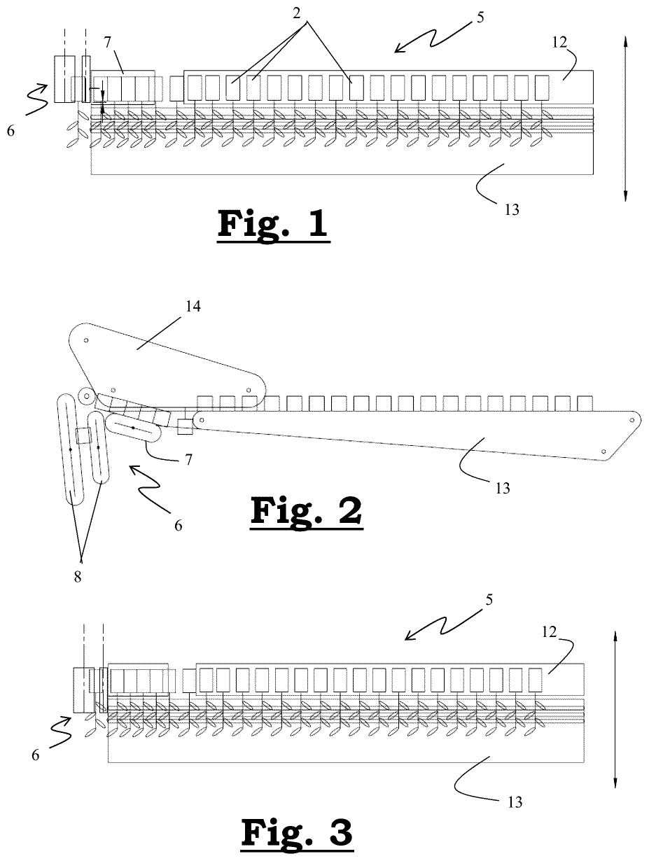

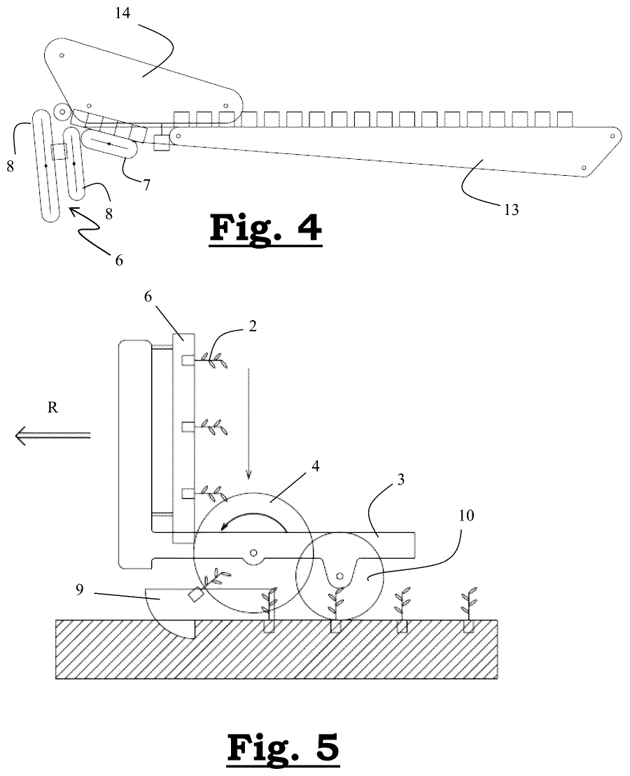

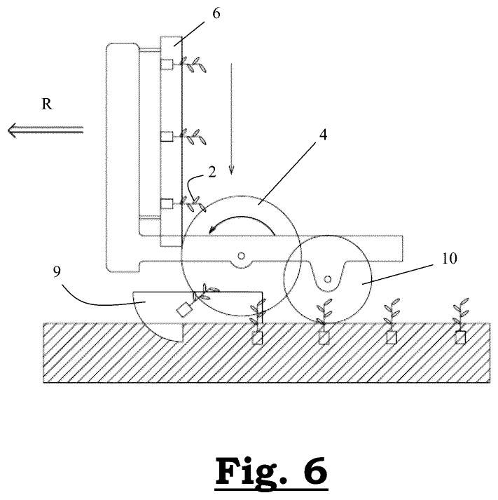

The gripping means of the gripping unit comprise two conveyor belts (13, 14), which can be seen inter alia in FIGS. 2 and 4, and are indicated here as a third conveyor belt (13) and a fourth conveyor belt (14). The third conveyor belt (13) extends, as shown inter alia in FIGS. 1 and 3, parallel next to the second conveyor belt (12) at the same height, so that seedlings that are supported and transported by the second conveyor belt (12) are also supported by the third conveyor belt (13), at the level of their above-ground portion. This third conveyor belt (13) extends farther than the second conveyor belt (12) so that the third conveyor belt (13) bridges the opening between the second (12) and first conveyor belt (7). The fourth conveyor belt (14) extends above the third conveyor belt (13) and extends from the end zone of the second conveyor belt (12) to the start zone of the first conveyor belt (7) and thus bridges said opening. All conveyor belts are configured to rotate at roughly the same speed and the third conveyor belt (13) almost touches the fourth conveyor belt (14) so that the third and the fourth conveyor belt (13, 14) are able to clamp above-ground portions and thus grip them at the level of the end zone of the second conveyor belt (12) and thus convey them to the start zone of the first conveyor belt (7). The fourth conveyor belt (14) is movable relative to the second conveyor belt (12) between various positions. It is thus possible to determine what the minimum height of the above-ground portions must be before they are gripped by the gripping means. It is therefore possible to separate the seedlings into two streams on the basis of the height of the above-ground portions.

At the end of the first feeders (in the device illustrated, this is at the end of the first conveyor belt (7)), the planting material (2) is received, preferably by gravity, by the second feeders (6). The second feeders (6) are formed by two endless clamping bands (8) at a distance from each other, which are configured to move the planting material downwards in the direction of the planting means. During the downward movement, the planting material (2) is clamped at the level of its root ball by the clamping bands (8). An innovation in the planting device (1) according to some embodiments of the present invention is that the first (5) and second feeders (6) are movable relative to each other. In practice, the first feeders (5) will be moved relative to the second feeders (6). By adjusting the position of the first feeders relative to the second it is possible to change the position of entry of the planting material into the second feeders, in particular between the two clamping bands (8). Thus, when, as shown in FIG. 1, the first feeders are moved backwards, the planting material supplied with the first feeders (which, as shown in FIG. 1, is always located at the same place on the transport surface of the first feeders) is brought further back in the second feeders (6). Therefore the planting material supplied by the second feeders is taken closer to the root ball by the planting means and the plants, as illustrated in FIG. 5, thus end up less deep, at a first planting depth in the ground, preferably in a furrow that has been provided.

If we want to change the planting depth, in particular to choose to plant the planting material deeper, at a second planting depth that is deeper than the first planting depth, then as shown in FIG. 3, the first feeders should be placed further forward (towards the front of the planting device), in a direction in the direction of travel (R). As a result, the planting material supplied with the first feeders (5) will be brought further forward in the second feeders. Therefore the planting material (2) supplied by the second feeders (6) will be taken farther from the root ball than in the arrangement described before, by the planting means (4) and the plants thus end up deeper, at a second planting depth in the ground, preferably in a furrow that has been provided.

Now, to change the planting depth, only the first (5) and second feeders (6) have to be moved relative to each other. The position of the planting means (4) relative to the ground remains unchanged. With a planting device (1) of this kind, it is consequently easy to adjust the planting depth easily as a function of for example the soil conditions or the type of planting material.

1. Planting device for placing planting material in the ground, comprising:
a frame movable in a direction of travel (R),
feeders for delivering the planting material to be planted, and, fitted to the frame, rotatable planters provided for gripping the supplied planting material and bringing it into the ground,
wherein the feeders comprise first and second feeders that extend, respectively, in a horizontal plane and towards the ground, wherein the second feeders are configured to transport the planting material supplied by the first feeders to the rotatable planters,
wherein the first and second feeders are movable relative to each other, for adjusting the planting depth of the planting material,
wherein the first feeders deliver the planting material to be planted in a first feed direction, and
wherein the position of the first feeders relative to the second feeders is movable horizontally in a direction transverse to the first feed direction, so that the planting depth of the planting material is adjustable.

2. Planting device according to claim 1, wherein first the feeders comprise at least one first conveyor belt.

3. Planting device according to claim 1, wherein the second feeders comprise two clamping bands extending towards the ground, between which the planting material supplied by the first feeders is transported in the direction of the planters.

4. Planting device according to claim 1, further comprising one or more drill coulters for making one or more furrows, and wherein the planting device is configured to bring the planting material into the one or more furrows, wherein the planting device further comprises one or more pressure rolls or pressure wheels for closing up the one or more furrows again after the planting material has been applied in the one or more furrows.
